(19) United States
(12) Patent Application Publication
(10) Pub. No.: US 2022/0397747 A1
(43) Pub. Date: Dec. 15, 2022

(54) OBJECTIVE, USE OF AN OBJECTIVE AND MEASUREMENT SYSTEM

(71) Applicant: Jenoptik Optical Systems GmbH, Jena (DE)

(72) Inventors: Tobias HOENLE, Jena (DE); Hagen SCHWEITZER, Schleiz (DE)

(73) Assignee: Jenoptik Optical Systems GmbH, Jena (DE)

(21) Appl. No.: 17/777,235

(22) PCT Filed: Nov. 10, 2020
(86) PCT No.: PCT/EP2020/081648

§ 371 Date: May 16, 2022

(30) Foreign Application Priority Data
Nov. 15, 2019 (DE) 10 2019 131 000.8

(51) Int. Cl. G02B 13/22; G02B 9/34; G02B 13/18; G01S 7/481; G01S 17/89; G01S 17/10

(52) U.S. Cl. CPC G02B 13/22; G02B 9/34; G02B 13/18; G01S 7/4811; G01S 17/89; G01S 17/10

(57) ABSTRACT

The invention relates to a hybrid objective with fixed focal length, which has a total of four lenses. Two lenses consist of glass and two lenses consist of plastic. The objective is suitable for use in a LID AR measurement system.

### TECHNICAL FIELD

The invention relates to an objective having a fixed focal length. Such an objective is particularly suitable for use in a measurement system for time-of-flight detection of a light beam (LIDAR). LIDAR is the abbreviation for light detection and ranging. LIDAR objectives usually work within a very small wavelength range in the near infrared, typically at 800-2000 nm. Lasers are often used for illumination purposes. In this case, the objectives must be able to compensate for the narrow bandwidth of the laser source and for any wavelength drift that may occur with temperature.

### PRIOR ART

A sensor having a SPAD array is known from WO 2017/180277 A1. The SPAD array can comprise avalanche photodiodes (APD) and bipolar or field effect transistors to activate a bias voltage (bias) row by row.

CN 205829628 U discloses a LIDAR system having a VCSEL array and a SPAD array.

An integrated illumination and detection system for LIDAR-based three-dimensional image recording is known from WO 2017/164989 A1. An objective having four lenses is proposed. A pulsed laser light source is proposed for the illumination. In one embodiment, an array of multiple LIDAR measurement devices consisting of laser emitters and detectors is used. However, such a procedure is highly complex.

A LIDAR system having electrically adjustable light directional elements is known from WO 2016/204844 A1.

A LIDAR system having a SPAD array as a detector is known from US 2016/0161600 A1. For illumination, laser beams which are controlled by means of integrated photonic circuits using optical phase arrays are used.

A vehicle LIDAR system having a solid-state laser and a deflectable mirror is known from WO 2015/189024 A1.

WO 2015/189025 A1 discloses a vehicle LIDAR system having a pulsed laser and a deflectable mirror and a CMOS image sensor.

A LIDAR device having an array of emitter/detector units is known from WO 2015/126471 A2.

A vehicle LIDAR system having a VCSEL array for illumination is known from US 2007/0181810 A1.

US 2014/0049842 A1 discloses an imaging objective having four lenses, which can be used for cameras in vehicles or for monitoring purposes. The disadvantage is that the imaging properties can be temperature-dependent if two of the lenses are made of inexpensive plastic.

### OBJECT OF THE INVENTION

The object of the invention is to provide an inexpensive objective that is operable over a wide temperature range and has the best possible image-side telecentricity and low F-theta distortion.

In particular, the objective should be suitable for LIDAR systems having detector arrays, for example SPAD arrays. In particular, the objective should be suitable for LIDAR systems without moving parts. In addition, the objective can be suitable as an imaging objective or as a projection objective.

### Solution to the Problem

The object is achieved by an objective as claimed in claim 1, by the use as claimed in claim 10, and by a measurement system as claimed in claim 11.

### Advantages of the Invention

The objective is inexpensive to manufacture and particularly suitable for LIDAR applications. It is characterized by passive athermalization, good image-side telecentricity, and low F-theta distortion. It can also be suitable for other applications as an imaging objective or as a projection objective.

### DESCRIPTION

An objective according to the invention has a fixed focal length F. It comprises at least a first lens with a first focal length f₁ made of a first glass, a second lens with a second focal length f₂ made of a first plastic, a third lens with a third focal length f₃ made of a second glass, and a fourth lens with a fourth focal length f₄ made of a second plastic. The indices of the focal lengths are chosen according to the number of the respective lens. The reciprocal of any focal length is known to be its refractive power. A refractive power can thus be assigned to each of the lenses. According to the invention, the first lens is designed as a meniscus with a negative refractive power, which can be denoted by D₁=1/f₁. According to the invention, the third lens has a positive refractive power D₃=1/f₃, which can be expressed as D₃>0. The sum D₃+D₄ of the refractive power D₃=1/f₃ of the third lens and the refractive power D₄=1/f₄ of the fourth lens is positive, which can be expressed as D₃+D₄>0. The fourth lens has at least one aspheric surface. According to the invention, the focal lengths are selected so that

$$\vert \frac{{f}_{2}}{{f}_{4}} + 1 \vert \leq 0.1 and / or \vert \frac{1}{{f}_{2}} + \frac{1}{{f}_{4}} \vert \leq \frac{0.015}{F} .$$

The focal lengths can therefore be selected in such a way that the absolute value of the ratio of the second to the fourth focal length increased by one is less than or equal to 0.1 and/or that the absolute value of the sum of the reciprocals of the second and fourth focal length is less than or equal to 0.015 times the focal length of the objective. An objective can be particularly advantageous if both conditions are met.

The objective can be particularly advantageous if the focal lengths are selected in such a way that

$$\vert \frac{{f}_{2}}{{f}_{4}} + 1 \vert \leq 0.05 and / or \vert \frac{1}{{f}_{2}} + \frac{1}{{f}_{4}} \vert \leq \frac{0.01}{F} .$$

Particularly good passive athermalization of the objective can then be achieved. The objective can advantageously have a focal length F of between 2 mm and 5 mm. The focal length f₁ of the first lens can advantageously be between −20 times and −4 times, particularly advantageously between −8 times and −6 times, the focal length F of the objective. The focal length f₃ of the third lens can advantageously be between 2 and 5 times the focal length F of the objective. The focal length f₄ of the fourth lens can advantageously be between −2 and 10 times the focal length F of the objective. The focal length f₄₀f the fourth lens can advantageously be between 0.8 times and 3 times the focal length f₃ of the third lens.

The focal length of a lens can be understood to mean the focal length with regard to paraxial (in the sense of near-axis) rays in an external medium with a refractive index of 1.

The first glass and the second glass can be different glasses. The first and the second glass can differ in terms of thermal expansion and/or the refractive index and/or the temperature dependence of the refractive index. Alternatively, however, it is also possible to use the same type of glass as the first and second glass. Optical glasses such as BK7 or borosilicate glass can be used herefor. High-index glasses, for example dense flint glasses (SF glasses), lanthanum-containing flint or crown glasses (e.g. LaF, LaSF or LaK glasses) or barium-containing flint or crown glasses (e.g. BaF or BaSF or BaK glasses) can be particularly suitable. The second glass can advantageously have a higher refractive index than the first glass. For example, the first glass can have a refractive index of between 1.50 and 1.55. A glass with a refractive index of more than 1.8 can be used as the second glass. The second glass may be a high-refractive lanthanum flint glass.

The first plastic and the second plastic can be different plastics. The first and the second plastic can differ in terms of thermal expansion and/or refractive index and/or temperature dependence of the refractive index. Alternatively, however, it is also possible, and under certain circumstances even particularly advantageous, to use the same type of plastic for the first and the second plastic. A plastic can be understood to mean a polymer. A transparent, i.e. a see-through, polymer can be particularly advantageous. Polycarbonate, COP, Zeonex, COC (Topas) or OKP can be particularly suitable. PMMA can likewise be suitable.

The objective can have an optical axis. The optical axis can be referred to as the z axis.

The objective according to the invention comprises four lenses. It can advantageously comprise exactly four lenses. In addition, it can comprise further elements, for example stop rings, filters, polarizers, etc. The objective according to the invention is cheaper to produce than objectives having more than four lenses. The further elements can advantageously be designed without any refractive power, i.e. without curvature of the optical interfaces.

A meniscus lens can be understood to mean a convex-concave lens. Advantageously, the concave side of the first lens can be more curved than the convex side. It can be a meniscus with negative refractive power, which can also be referred to as a negative meniscus. Advantageously, the first lens can be outwardly curved, i.e. in a negative z direction. This can mean that the first lens can be an external lens with respect to the objective and that its convex surface can be arranged externally with respect to the objective.

The first lens and/or the second lens can advantageously have at least one aspheric surface.

A spherical lens can be understood to mean a lens that has two opposing spherical optical surfaces. A spherical lens can also be called a bi-spherical lens. One of the spherical surfaces can be a plane surface. A plane surface can be understood to mean a spherical surface with an infinite radius of curvature. The second lens can be an aspheric lens.

An aspheric lens can refer to a lens with at least one aspheric optical surface. The second lens can also be designed as a bi-aspheric lens. A bi-aspheric lens can be understood to mean a lens that has two opposing aspheric optical surfaces. The second lens can have at least one free-form surface.

It can likewise be advantageous if the first lens and the third lens are designed as spherical lenses, and the second and fourth lenses are designed as aspheric lenses, i.e. with at least one aspheric surface each. The second lens can be designed particularly advantageously as a bi-aspheric lens. In a particularly advantageous manner, both the second lens and the fourth lens can be configured as bi-aspheric lenses.

The first lens, the second lens, the third lens, and the fourth lens can advantageously be arranged one after the other in a z direction in the beam path. The image plane of the objective can be arranged downstream of the fourth lens in the z direction. An object plane can be arranged upstream of the first lens. The objective can then be an imaging objective. An image sensor for recording an image or a matrix sensor for detecting the time of flight of light beams can be arranged in the beam path downstream of the fourth lens, advantageously in the image plane of the objective. The light beams can propagate from the object to the image plane with a component in the z direction.

A light source, the fourth lens, the third lens, the second lens, and the first lens can likewise advantageously be arranged one after the other in a −z direction in the beam path. The objective can then be used to illuminate objects or scenes located in the −z direction from the first lens. The light beams can propagate from the light source with a component in the −z direction to the object or scene to be illuminated. A scene can be understood to mean a number of objects that are to be detected and/or illuminated within a specific solid angle range.

A stop can advantageously be arranged between the second lens and the third lens. The stop may be an opening in a stop component. The stop component can be ring-shaped. The stop component can have a first and/or a second cone frustum lateral surface, which is arranged in the interior of the stop component and delimits a cutout in the stop component. The cone frustum lateral surfaces can be arranged rotationally symmetrically to the optical axis. The first cone frustum lateral surface can be the cone frustum lateral surface facing the second lens, and the second cone frustum lateral surface can be the cone frustum lateral surface facing the third lens. The smallest radius of the lateral surface of the truncated cone can represent the stop. Advantageously, the first and the second cone frustum lateral surfaces can intersect. Then the smallest radius of both cone frustum lateral surfaces can be the same and represent the stop. The intersection edge, i.e. the line of intersection of the cone frustum lateral surfaces, can be deburred or chamfered in order to be able to produce them reproducibly. If there is only one cone frustum lateral surface, the smallest radius thereof can be arranged at the edge of the stop component.

At the same time, the stop component can be designed as a spacer between the second and the third lens. The telecentricity error and/or the distortion can be reduced and/or vignetting can be minimized or avoided by this choice of the stop plane. The stop plane can be located between the second and the third lens.

Advantageously, the objective can be designed to be approximately telecentric on the image side. This means that the telecentricity error on the image side is less than 5°. This configuration of the objective can be particularly advantageous if a filter, for example a bandpass filter, is arranged between the fourth lens and the image plane. Such an advantageous arrangement can additionally comprise an image sensor for image recording or a matrix sensor for time-of-flight detection of a light beam, which can be arranged in the image plane. With such an arrangement of the objective and the filter, inhomogeneity in the full-area illumination of the image plane as a result of different angles of incidence on the filter can be avoided. The angular acceptance range requirements for the filter may be reduced compared to a non-telecentric objective. This allows the filter to be less expensive. An image-side telecentricity error can be understood to mean the angular deviation between the optical axis and the chief rays between the last lens and the image sensor. The rays that intersect with the optical axis in the stop plane can be referred to here as the chief rays. If no stop is present, the rays with the mean angle with respect to the bundle of rays striking the image plane at a specific point can be assumed to be the chief rays. Advantageously, the fourth lens can be of biconvex design. The fourth lens can likewise advantageously be designed as a meniscus with a positive refractive power. Particularly advantageously, the concave surface of such a meniscus can lie in the positive z direction, i.e. facing the image plane or the light source, in order to achieve the smallest possible image-side telecentricity error.

The objective can advantageously have a photographic luminous intensity of at least 1:1.3. Photographic luminous intensity can be referred to as the maximum aperture ratio of the objective. The reciprocal of the photographic luminous intensity can be referred to as the f-number. The condition can also be expressed in such a way that the f-number should be less than 0.77.

The objective can advantageously comprise a bandpass filter for separating the signal light of the light source from the ambient light, in particular from daylight. However, a bandpass filter can also be arranged outside the objective in the beam path.

The objective is operable as a projection objective. However, it can also be operable as an imaging objective.

The use of the objective can be advantageous for a measurement system for at least one time-of-flight detection of at least one light beam. The measurement system can advantageously comprise at least one objective, at least one light source, and at least one matrix sensor. The light source can be a laser beam source or an LED. The light source is operable in a pulsed manner. The pulse length can be between 1 ns and 1 ms.

The measurement system can be characterized in that the matrix sensor is a SPAD array and/or that the light source is a VCSEL array or an LED array.

The second lens can advantageously be designed in such a way that both optical surfaces of the second lens are designed to be concave at least in a central region. The central region can be understood to mean a region close to the optical axis. This region can be determined by it containing all points within a specific radius around the optical axis. The surface of the second lens facing the first lens, i.e. the object-side surface in the case of the imaging objective, can additionally have a convex region. This convex region may be located peripherally with respect to the optical axis. A peripheral region can be understood to mean a region containing the points outside a specific radius around the optical axis. This region can be ring-shaped. The optical surface of the second lens facing the third lens, i.e. the image-side optical surface in the case of the imaging objective, can be designed to be concave everywhere.

The objective can comprise one or more spacers arranged between two lenses. The spacers can advantageously be produced from polycarbonate or from a glass fiber reinforced plastic. It may alternatively be produced from a metal such as aluminum or steel.

The objective can have a focal length, an image point size, a modulation transfer function, and a distortion in the image plane. The focal length of the objective and/or at least one of the optical properties image point size, modulation transfer function, image size, distortion in the image plane, can be independent of the temperature at a first wavelength over a temperature range without the use of active components. This can be referred to as passive athermalization.

Passive athermalization can be achieved through the abovementioned selection of the lens materials in connection with the abovementioned limitations of the focal length ratios.

The objective can be designed for an individual wavelength (design wavelength), for example that of a specific laser radiation, for example 780 nm, 808 nm, 880 nm, 905 nm, 915 nm, 940 nm, 980 nm, 1064 nm or 1550 nm. However, the objective can also be designed for a specific bandwidth, for example for the visible wavelength range or the near infrared range, or for a plurality of discrete wavelengths. The bandwidth provided can also be 20 nm to 50 nm, for example, in order to be able to compensate for thermal wavelength drift of a diode laser provided for the illumination, for example.

The objective is operable as a projection objective. For example, a laser beam can thereby be projected linearly or over an area into a section of space.

The objective is operable as an imaging objective. A light beam reflected by an object, for example a laser beam, which has been reflected from a point on the object can be projected onto a point on the detector. The time of flight of this light beam can be detected with the detector.

In a preferred embodiment, the objective can be used simultaneously as a projection objective and as an imaging objective. The laser beam to be projected can be coupled into the beam path by means of a beam splitter arranged in the beam path between the objective and the detector.

The objective can be designed as a wide-angle objective with an aperture angle (full angle) of more than 160°, particularly advantageously more than 170°, and very particularly advantageously more than 175°.

The use of an objective with a fixed focal length F can be advantageous for a measurement system for at least one time-of-flight detection of at least one light beam. The light beam can be a laser beam. The light beam can be emitted by a light source. The light source can be an optically pumped solid state laser or an electrically pumped diode laser. The light source can be arranged together with the objective according to the invention and a detector on a vehicle. The light source can be designed in such a way that individual light pulses are emittable. A photoelectric detector can be provided for the time-of-flight detection of the light beam. The detector can be designed as an avalanche photodiode, for example a single photon avalanche diode (abbreviated to SPAD). The detector can comprise a plurality of avalanche photodiodes. These can be designed as a SPAD array.

A measurement system according to the invention comprises at least one objective according to the invention, at least one light source, and at least one matrix sensor. The light source can emit at least one signal light. The latter can differ from the ambient light in terms of the wavelength. The light source can advantageously be a laser light source. It can be an infrared laser. Alternatively, the light source can be an LED.

The light source is operable in a pulsed manner. The pulse length can be between 1 ns and 1 ms.

In a further embodiment, the light source can comprise a plurality of light-emitting elements which are operable independently of one another. The light source can be in the form of a VCSEL array or an LED array. Operation of the light source, in which at least two of the light-emitting elements emit light pulses at different points in time, can be provided.

The matrix sensor can be a SPAD array.

The figures show the following:

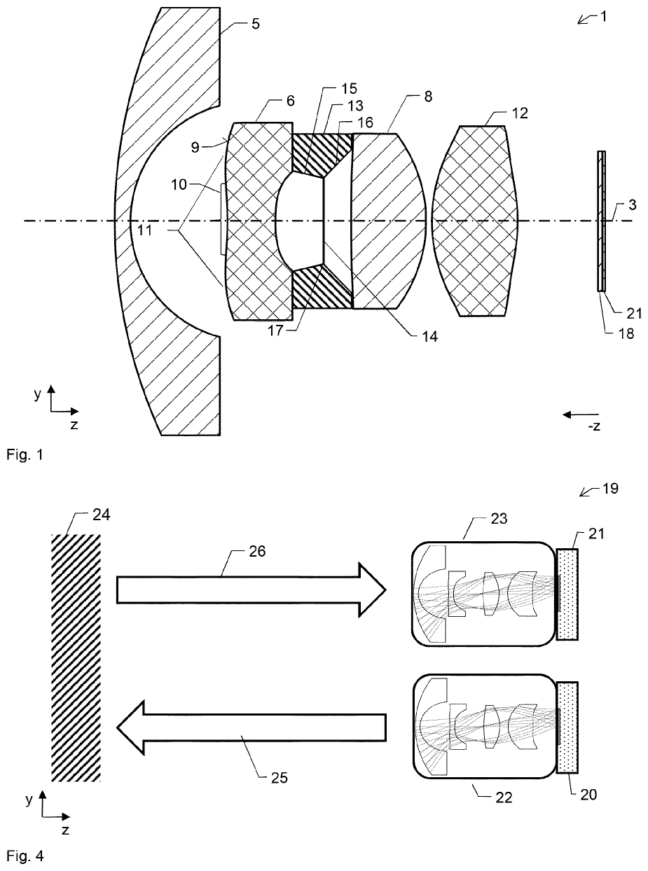

FIG. 1 shows a first exemplary embodiment.

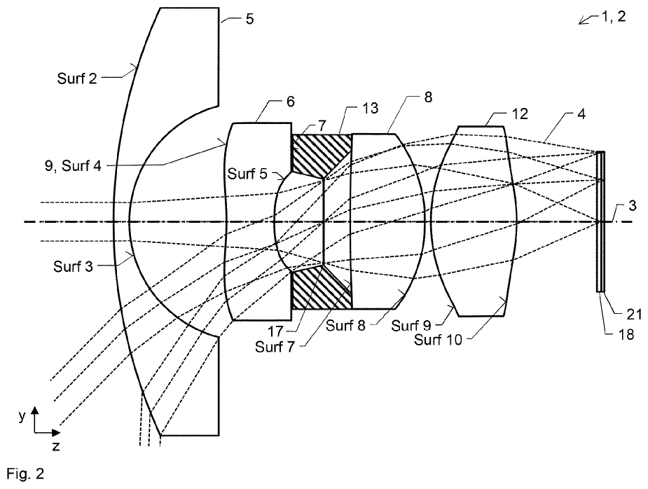

FIG. 2 shows the beam path of the first exemplary embodiment.

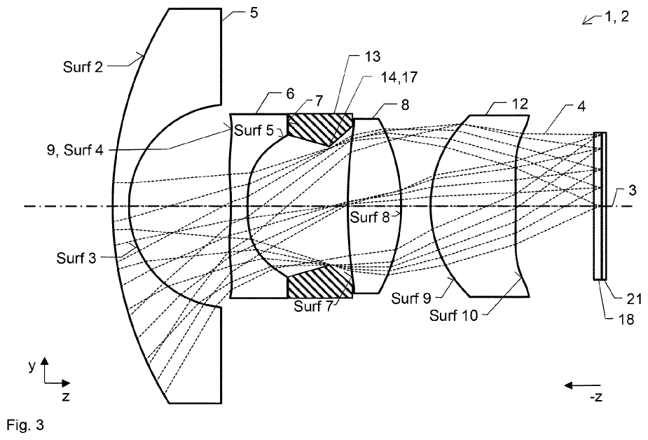

FIG. 3 shows a second exemplary embodiment.

FIG. 4 shows a measurement system according to the invention.

### EXEMPLARY EMBODIMENTS

The invention will be explained below using exemplary embodiments.

FIG. 1 shows a first exemplary embodiment. An objective 1 with a fixed focal length F is shown. The objective has an optical axis 3. The optical axis is in the z direction. In the figures, the image plane is disposed on the right, i.e. in the z direction, while the object plane is situated to the left of the objective. The objective comprises a first lens 5, a second lens 6, and a third lens 8, and a fourth lens 12. The lenses are arranged sequentially in the z direction in the order mentioned.

The first lens is produced from a first glass. The first lens is a spherical meniscus lens with negative refractive power, i.e. it has two opposing spherical optical surfaces.

The second lens 6 is produced from a first plastic. The second lens 6 is designed as a bi-aspheric diverging lens. In this exemplary embodiment, the second lens 6 is designed such that the object-side surface 9 (on the left in the illustration) is concave in a central region 10 (indicated with a bracket in the figure) and convex in a peripheral region 11.

The third lens 8 is produced from a second glass. The third lens 8 is a spheric converging lens.

The fourth lens 12 is designed as a bi-aspheric converging lens. It is produced from a second plastic. The second plastic here is the same as the first plastic.

A spacer 13 is arranged between the second lens 6 and the third lens 8. The spacer has an opening which acts as a stop 14. The opening is formed from a first cone frustum lateral surface 15 and a second cone frustum lateral surface 16. The intersection edge of the cone frustum lateral surfaces is an intersection edge 17, which represents the aperture. The stop is designed as an intersection edge. In a modification of the exemplary embodiment that is not shown in the figures, the stop can also be designed as a stop ring. In a further modification of the exemplary embodiment that is not shown in the figures, the stop is selected in the plane of a contact surface 7 of the second lens. It is then possible to make this surface such that it absorbs light and to use it as a stop.

A filter 18 is additionally provided, which separates the signal light from the ambient light.

FIG. 2 shows the beam path of the first exemplary embodiment. In this figure, the hatching of the lenses has been omitted in order to be able to better show the light beams 4, which represent the beam path 2. An image sensor for recording an image or a matrix sensor for detecting the time of flight of a light beam is arranged in the image plane 21.

The optical design is implemented according to Table 1 below:

TABLE 1

| | | | Radius of curvature | Thickness/ | | Radius in |
|---|---|---|---|---|---|---|
| No. | Type | Comment | KR in mm | distance in mm | Material | mm |
| 1 | STANDARD | Object | ∞ | ∞ | Air | 0.000000 |
| 2 | STANDARD | Lens 1 | 29.264432 | 1.000000 | Glass 1 (n = 1.5168) | 13.421635 |
| 3 | STANDARD | | 6.788618 | 5.450270 | Air | 6.680311 |
| 4 | ASPHERE | Lens 2 | −13.088044 | 2.819898 | Polymer 1 (n = 1.5300) | 6.072270 |
| 5 | ASPHERE | | 9.829847 | 2.770944 | Air | 2.800000 |
| 6 | STANDARD | Stop | ∞ | 1.447852 | Air | 2.350000 |
| 7 | STANDARD | Lens 3 | 82.915075 | 4.386519 | Glass 2 (n = 1.9037) | 4.289719 |
| 8 | STANDARD | | −8.242710 | 0.221858 | Air | 5.275803 |
| 9 | ASPHERE | Lens 4 | 9.030488 | 5.000000 | Polymer 2 (n = 1.5300) | 5.679712 |
| 10 | ASPHERE | | −9.938689 | 4.524408 | Air | 5.912429 |
| 11 | STANDARD | Filter | ∞ | 0.378000 | n = 1.5000 | 4.382981 |
| 12 | STANDARD | Image | ∞ | 0.000000 | | 4.325120 |

The first column gives a sequential number of a surface and is numbered from the object side. The “Standard” type designates a planar or spherically curved surface. The “ASPHERE” type designates an aspheric surface. A surface can be understood to mean an interface or lens surface. It should be noted that the object plane (no. 1), a stop (no. 6), and the image plane (no. 12) are additionally considered to be surfaces. Surfaces 2, 3, 4, 5, 7, 8, 9 and 10 are lens surfaces. These surfaces are denoted in FIG. 2 by the respective number as Surf 2, Surf 3, Surf 4, Surf 5, Surf 7, Surf 8, Surf 9 and Surf 10.

The Radius of curvature KR column indicates the radius of curvature of the respective surface. In the case of an aspheric surface, this is understood to mean the paraxial radius of curvature. In the table, the sign of a radius of curvature is positive if the shape of a surface is convex toward the object side, and the sign is negative if the shape of a surface is convex toward the image side. The specification—in the Radius of curvature column means that it is a planar surface. The distance between the i-th surface and the (i+1)-th surface on the optical axis is specified in the “Thickness/distance” column. The specification—in this column in no. 1 means that the object distance is infinite, i.e. an objective focused at infinity. For rows 2, 4, 7 and 9, this column gives the center thickness of the first, second, third and fourth lenses, respectively. In the Material column, the material between the respective surfaces is specified with the respective refractive index n. The refractive index n refers to a design wavelength for which the objective is designed. The design wavelength can for example be between 700 nm and 1100 nm or between 1400 nm and 1600 nm, for example at 905 nm, 915 nm, 940 nm, 1064 nm or 1550 nm. The Radius column specifies the outer radius of the respective surface. In the case of the stop (no. 6), that is the aperture. In the case of the lens surfaces, this is the maximum usable distance of the light beams from the optical axis, which, in the equation below, corresponds to the maximum value h for the respective surface.

In the following two tables (Table 2, Table 3), the coefficients of the aspheric surfaces are given for the respective surface number.

TABLE 2

| No. | C₂ in mm−1 | C₄ in mm−3 | C₆ in mm−5 | C₈ in mm−7 |
|---|---|---|---|---|
| 4 | 0.0000000E+00 | 3.8946765E−03 | −1.9916747E−04 | 9.3959964E−06 |
| 5 | 0.0000000E+00 | 7.2821395E−03 | 7.6976794E−04 | −4.1404616E−04 |
| 9 | 0.0000000E+00 | −3.2477297E−04 | 4.4136483E−05 | −5.1107094E−06 |
| 10 | 0.0000000E+00 | 1.2815739E−03 | 3.1453468E−05 | −4.9419416E−06 |

TABLE 3

| No. | C₁₀ in mm−9 | C₁₂ in mm−11 | C₁₄ in mm−13 | C₁₆ in mm−15 |
|---|---|---|---|---|
| 4 | −3.2268213E−07 | 7.3829174E−09 | −9.9657773E−11 | 5.9756551E−13 |
| 5 | 9.9825464E−05 | −1.0939844E−05 | 4.9478924E−07 | 0.0000000E+00 |
| 9 | 3.8726105E−07 | −1.7725428E−08 | 4.2761827E−10 | −4.3462716E−12 |
| 10 | 3.6159105E−07 | −1.4520099E−08 | 2.6777834E−10 | −1.8307264E−12 |

In the numerical values of the aspheric data, “E−n” (n: integer) means “×10−n” and “E+n” means “×10n”. Furthermore, the aspheric surface coefficients are the coefficients Cₘ with m=2 . . . 16 in an aspheric expression represented by the following equation:

$$Z d = \frac{{h}^{2}}{K R + \sqrt{K {R}^{2} - ( 1 + k ) {h}^{2}}} + {\sum }_{m = 2}^{16} {C}_{m} \cdot {h}^{m} ,$$

Zd is the depth of an aspheric surface (i.e. the length of a perpendicular from a point on the aspheric surface at a height h to a plane touching the vertex of the aspheric surface and perpendicular to an optical axis), h is the height (i.e. a length from the optical axis to the point on the aspheric surface), KR is the paraxial radius of curvature, and Cₘ denotes the aspheric surface coefficients given below (m=2 . . . 16). Unspecified aspheric surface coefficients, here all with an odd-numbered index, are to be assumed to be zero. The coordinate h is to be used in millimeters, as is the radius of curvature; the result Zd is obtained in millimeters. The coefficient k is the conicity coefficient, which in the present exemplary embodiment is zero for all surfaces.

The focal length of the first lens is f₁=−17.7 mm, that of the third lens is f₃=8.7 mm. The focal length of the second lens is f₂=−10.3 mm, that of the fourth lens is f₄=9.95 mm. The objective has a focal length F of 2.78 mm.

In a modification of this exemplary embodiment, the objective is focused at a finite object distance. This can be accomplished by changing the image width. For this purpose, the distance in line no. 10 can be increased accordingly.

In a further modification (not shown), the objective can be used as a projection objective. For this purpose, a light source is arranged in the plane 21, rather than the sensor. A scene located in the negative z direction, identified as the −z direction in FIG. 1, upstream of the objective can then be illuminated.

FIG. 3 shows a second exemplary embodiment. This will be described in the following paragraphs. In this figure, the hatching of the lenses has been omitted in order to be able to better show the light beams 4, which represent the beam path 2. In accordance with the statements given under the first exemplary embodiment, the optical design of the second exemplary embodiment is implemented according to Table 4 below:

TABLE 4

| | | | Radius of | Thickness/ | | |
|---|---|---|---|---|---|---|
| | | | curvature KR | distance | | Radius in |
| No. | Type | Comment | in mm | in mm | Material | mm |
| 1 | STANDARD | Object | ∞ | ∞ | Air | 0.000000 |
| 2 | STANDARD | Lens 1 | 21.700000 | 1.000000 | Glass 1 (n = 1.5168) | 11.006013 |
| 3 | STANDARD | | 5.900000 | 5.890000 | Air | 5.834891 |
| 4 | ASPHERE | Lens 2 | −12.300000 | 1.000000 | Polymer 1 (n = 1.5300) | 4.874867 |
| 5 | ASPHERE | | 14.200000 | 4.900000 | Air | 3.630000 |
| 6 | STANDARD | Stop | ∞ | 0.886000 | Air | 3.433203 |
| 7 | STANDARD | Lens 3 | 31.200000 | 3.150000 | Glass 2 (n = 1.9037) | 4.191108 |
| 8 | STANDARD | | −10.500000 | 1.660000 | Air | 4.595297 |
| 9 | ASPHERE | Lens 4 | 7.400000 | 5.000000 | Polymer 2 (n = 1.5300) | 4.800000 |
| 10 | ASPHERE | | −37.700000 | 4.570000 | Air | 4.800000 |
| 11 | STANDARD | Filter | ∞ | 0.500000 | n = 1.5000 | 4.225592 |
| 12 | STANDARD | Image | ∞ | 0.000000 | | 4.232742 |

The coefficients of the aspheric surfaces given in the following tables (Table 5, Table 6) (asphere-type surfaces with the respective number given in Table 4 above) were used:

TABLE 5

| No. | C₂ in mm−1 | C₄ in mm−3 | C₆ in mm−5 | C₈ in mm−7 |
|---|---|---|---|---|
| 4 | 0.00000E+00 | 6.66623E−03 | −4.20535E−04 | 1.52374E−05 |
| 5 | 0.00000E+00 | 8.56409E−03 | −1.23883E−04 | −2.27136E−05 |
| 9 | 0.00000E+00 | 1.22214E−04 | 1.25206E−05 | −2.08983E−06 |
| 10 | 0.00000E+00 | 2.13660E−03 | −7.95143E−05 | 1.52434E−05 |

TABLE 6

| No. | C₁₀ in mm−9 | C₁₂ in mm−11 | C₁₄ in mm−13 | C₁₆ in mm−15 |
|---|---|---|---|---|
| 4 | −3.32951E−07 | 3.16413E−09 | 0.00000E+00 | 0.00000E+00 |
| 5 | 2.40847E−06 | −6.93424E−08 | 0.00000E+00 | 0.00000E+00 |
| 9 | 1.78721E−07 | −8.46345E−09 | 2.09208E−10 | −2.23688E−12 |
| 10 | −1.56245E−06 | 9.49397E−08 | −3.08630E−09 | 3.87340E−11 |

Unspecified aspheric surface coefficients, here all with an odd-numbered index, are to be assumed to be zero. The conicity coefficients k of all surfaces are also equal to zero in this example.

The focal length of the first lens is f₁=−16.285 mm, that of the third lens is f₃=9.278 mm. The focal length of the second lens is f₂=−12.453 mm, that of the fourth lens is f₄=12.307 mm. The objective of this second exemplary embodiment has a focal length F of 3.302 mm.

The stop is designed as an intersection edge. In a modification of the exemplary embodiment that is not shown in the figures, the stop can also be designed as a stop ring. In a further modification of the exemplary embodiment that is not shown in the figures, the stop is selected in the plane of a contact surface 7 of the second lens. It is then possible to make this surface such that it absorbs light and to use it as a stop.

In a modification of this exemplary embodiment, the objective is focused at a finite object distance. This can be accomplished by changing the image width. For this purpose, the distance in line no. 10 can be increased accordingly.

In a further modification (not shown), the objective can be used as a projection objective. For this purpose, a light source is arranged in the plane 21, rather than the sensor. A scene located in the negative z direction, identified as the −z direction in FIG. 3, upstream of the objective can then be illuminated.

The design wavelength of the first and second exemplary embodiments is 905 nm. Modifications of the exemplary embodiments can also be used with other wavelengths stated in the description.

FIG. 4 shows a measurement system according to the invention. The measurement system 19 comprises a transmitter objective 22, a receiver objective 23, a light source 20, and a matrix sensor 21. The light source illuminates one or more objects 24 with transmitter light 25. The matrix sensor detects the time of flight of the reflected light 26.

### REFERENCE SIGNS

1. Objective
2. Lens arrangement with beam path
3. Optical axis
4. Light beam
5. First lens
6. Second lens
7. Contact surface
8. Third lens
9. Object-side surface of the second lens
10. Central region
11. Peripheral region
12. Fourth lens
13. Spacer
14. Stop
15. First cone frustum lateral surface
16. Second cone frustum lateral surface
17. Intersection edge
18. Filter
19. Measurement system
20. Light source
21. Matrix sensor
22. Transmitter objective
23. Receiver objective
24. Object
25. Transmitter light
26. Reflected light

1. An objective with a fixed focal length F, comprising at least a first lens with a first focal length f₁ made of a first glass, a second lens with a second focal length f₂ made of a first plastic, a third lens with a third focal length f₃ made of a second glass, and a fourth lens with a fourth focal length f₄ made of a second plastic,
wherein
the first lens is designed as a meniscus with a negative refractive power D₁=1/f₁,
the third lens has a positive refractive power D₃=1/f₃>0,
the sum D₃+D₄ of the refractive power D₃=1/f₃ of the third lens (8) and the refractive power D₄=1/f₄ of the fourth lens is positive,
the fourth lens has at least one aspheric surface,
and wherein
$$\vert \frac{{f}_{2}}{{f}_{4}} + 1 \vert \leq 0.1 and / or \vert \frac{1}{{f}_{2}} + \frac{1}{{f}_{4}} \vert \leq \frac{0.015}{F} .$$

2. The objective as claimed in claim 1, wherein the first lens and/or the second lens have at least one aspheric surface.

3. The objective as claimed in claim 1, wherein the first lens, the second lens, the third lens, and the fourth lens are arranged one after the other in a z direction in the beam path, or wherein at a light source, the fourth lens, the third lens, the second lens, and the first lens are arranged one after the other in the −z direction in the beam path.

4. The objective as claimed in claim 1, wherein a stop is arranged between the second lens and the third lens.

5. The objective as claimed in claim 1, wherein it has a focal length F of between 2 mm and 5 mm and/or in that the focal length f₁ of the first lens is between −20 times and −4 times the focal length F of the objective and/or in that the focal length f₃ of the third lens is between 2 and 5 times the focal length F of the objective and/or in that the focal length f₄ of the fourth lens is between 2 and 10 times the focal length F of the objective and/or in that the focal length f₄ of the fourth lens is between 0.8 and 3 times the focal length f₃ of the third lens.

6. The objective as claimed in claim 1, wherein it is designed to be approximately telecentric on the image side, wherein the image-side telecentricity error is less than 5°.

7. The objective as claimed in claim 1, wherein the objective has a photographic luminous intensity of at least 1:1.3.

8. The objective as claimed in claim 1, wherein the objective comprises a bandpass filter for separating the signal light of the light source from ambient light, in particular from daylight, or is operable together with a bandpass filter arranged outside the objective.

9. The objective as claimed in claim 1, wherein the objective is operable as a projection objective and/or in that the objective is operable as an imaging objective.

10. The use of an objective as claimed in claim 1 for a measurement system for at least one time-of-flight detection of at least one light beam.

11. A measurement system, comprising at least one objective as claimed in claim 1, at least one light source, and at least one matrix sensor.

12. The measurement system as claimed in claim 1, wherein the light source is a laser beam source or an LED and in that the light source is operated in a pulsed manner and in that the pulse length is between 1 ns and 1 ms.

13. The measurement system as claimed in claim 1, wherein the matrix sensor is a SPAD array and/or in that the light source is a VCSEL array or an LED array.
